(19) United States
(12) Patent Application Publication
(10) Pub. No.: US 2017/0300862 A1
(43) Pub. Date: Oct. 19, 2017

(54) MACHINE LEARNING ALGORITHM FOR CLASSIFYING COMPANIES INTO INDUSTRIES

(71) Applicant: Linkedln Corporation, Mountain View, CA (US)

(72) Inventors: Sameer Mahendra Bhadouria, San Francisco, CA (US); Aaron Tyler Rucker, San Francisco, CA (US); Jason Willard Carver, San Francisco, CA (US)

(21) Appl. No.: 15/099,137

(22) Filed: Apr. 14, 2016

(51) Int. Cl. G06Q 10/10; G06N 7/00; G06F 11/34; G06N 99/00; G06F 11/30

(52) U.S. Cl. CPC G06Q 10/1053; G06N 99/005; G06F 11/3024; G06F 11/3409; G06N 7/005

(57) ABSTRACT

In an example embodiment, a solution that automatically assigns one or more industries to a company in a job posting is provided using a machine learning algorithm. In a training phase, sample computerized job postings having labeled industries are fed into a machine learning algorithm to generate a raw industry classifier based on features comprising terms in a textual portion of the computerized job postings and one or more metrics for each of the terms. Newly acquired candidate job postings are aggregated by normalized company name and the aggregations are fed into the raw industry classifier to generate one or more industries corresponding to the normalized company name.

### TECHNICAL FIELD

The present disclosure generally relates to computer technology for solving technical challenges in detection of information in a computer system. More specifically, the present disclosure relates to a machine learning algorithm for classifying companies into industries.

### BACKGROUND

The rise of the Internet has given rise to two disparate phenomena: the increase in the presence of social networks, with their corresponding member profiles visible to large numbers of people, and the increase in advertising for job openings. This advertising may take the form of a direct placement of a job posting (having, for example, a description of the company and the job) with the social networking service, or may take the form of an indirect placement of a job posting (such as where the social networking service obtains the job posting from another web site or service, a process commonly known as “scraping”).

When the job posting is placed directly with the social networking service, there may be certain pieces of information that the social networking service may deem important enough to require when the advertiser places the job posting. This may include, for example, any piece of information that is likely to be searched upon by a member interested in a job, such as location of the job, description of the job, company name, and company industry. However, when the job posting is obtained by scraping, the social networking service may not have had any contact with the advertiser, and thus is unable to impose such requirements on the information received. As such, those important pieces of information may be missing from the job postings when the job postings were scraped from other sources. One commonly missing piece of information is the industry of the company. This information may be crucial, however, to indexing the job posting in the social networking service for searching by its members.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating the application server module of FIG. 2 in more detail in accordance with an example embodiment.

FIG. 4 is a block diagram illustrating a raw industry classifier used to automatically add one or more industries to a job posting, in accordance with an example embodiment.

FIG. 5 is a flow diagram illustrating a method of training of the raw industry classification model in more detail, in accordance with an example embodiment.

FIG. 6 is a flow diagram illustrating feature extraction in more detail, in accordance with an example embodiment.

FIG. 7 is a flow diagram illustrating a method of classifying industries for candidate job postings using a raw industry classification model, in accordance with an example embodiment.

FIG. 8 is a flow diagram illustrating a method of classifying industries for candidate job postings using a raw industry classification model, in accordance with an example embodiment.

FIG. 9 is a block diagram illustrating a representative software architecture, which may be used in conjunction with various hardware architectures herein described.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

The present disclosure describes, among other things, methods, systems, and computer program products that individually provide functionality for speeding data access. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, an automated solution for identifying industries relating to a company from a job posting using a machine learning algorithm is provided. The solution comprises a two phase process. In the first phase, offline training of a machine learning model is conducted by training a multi-class logistic regression model with labeled training data to generate a model with feature vectors and model coefficients. In the second phase, online classification of companies identified in previously unseen job postings is performed by using the trained model to associate one or more industries with the identified company. This process is able to handle a wide variety of job posting input to provide reliable results even when job posting information is noisy and could otherwise lead to false positives. For example, while many different types of companies may post job postings for software engineers, that does not make those companies software companies. An example would be a health care company looking to hire an IT engineer. The machine learning algorithm is able to correctly identify the industry as “health care” as opposed to “software” despite the fact that the job itself, and thus many of the keywords contained in the job posting, pertain(s) to software.

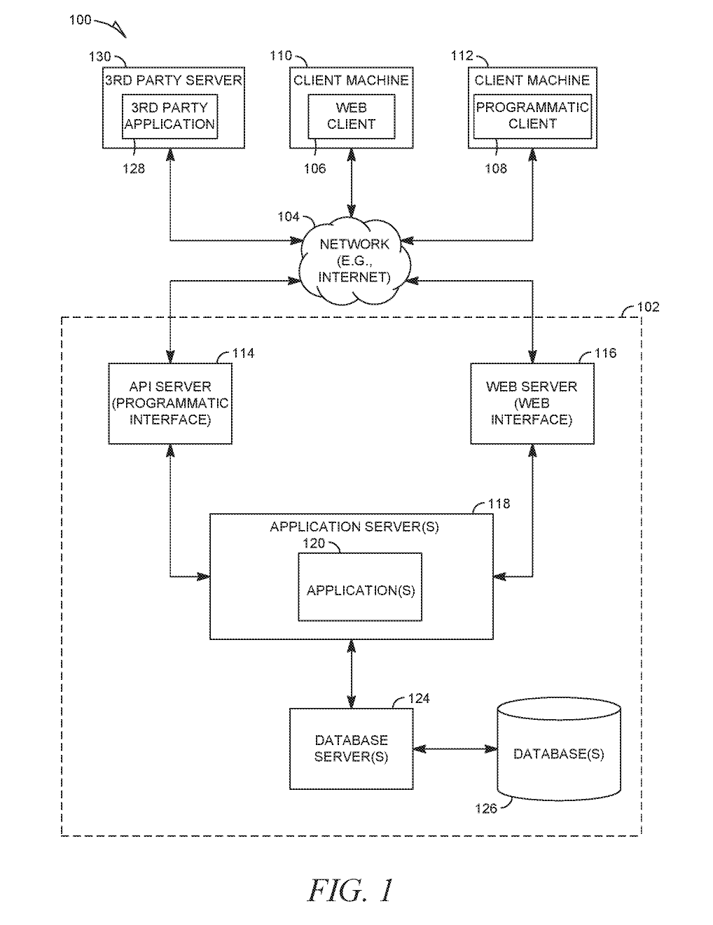

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by a third party. The third party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

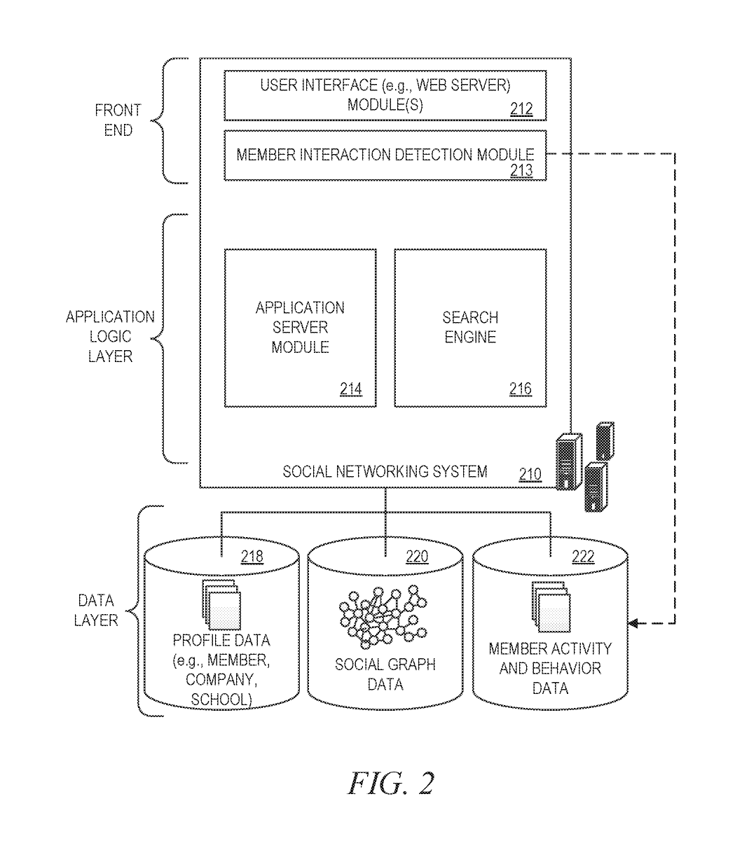

In some embodiments, the networked system 102 may comprise functional components of a social networking service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on the application server(s) 118 in FIG. 1, However, it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a member interaction detection module 213 may be provided to detect various interactions that members have with different applications 120, services, and content presented. As shown in FIG. 2, upon detecting a particular interaction, the member interaction detection module 213 logs the interaction, including the type of interaction and any metadata relating to the interaction, in a member activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the social networking service.

As shown in FIG. 2, the data layer may include several databases, such as a profile database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or offline) to generate various derived profile data. For example, if a member has provided information about various job titles that the member has held with the same organization or different organizations, and for how long, this information can be used to inter or derive a member profile attribute indicating the member's overall seniority level, or seniority level within a particular organization. In some embodiments, importing or otherwise accessing data from one or more externally hosted data sources may enrich profile data for both members and organizations. For instance, with organizations in particular, financial data may be imported from one or more external data sources and made part of an organization's profile. This importation of organization data and enrichment of the data will be described in more detail later in this document.

Once registered, a member may invite other members, or be invited by other members, to connect via the social networking service. A “connection” may constitute a bilateral agreement by the members, such that both members acknowledge the establishment of the connection. Similarly, in some embodiments, a member may elect to “follow” another member. In contrast to establishing a connection, the concept of “following” another member typically is a unilateral operation and, at least in some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph in a social graph database 220.

As members interact with the various applications 120, services, and content made available via the social networking service, the members' interactions and behavior (e.g., content viewed, links or buttons selected, messages responded to, etc.) may be tracked, and information concerning the members' activities and behavior may be logged or stored, for example, as indicated in FIG. 2, by the member activity and behavior database 222. This logged activity information may then be used by the search engine 216 to determine search results for a search query.

In some embodiments, the databases 218, 220, and 222 may be incorporated into the database(s) 126 in FIG. 1, However, other configurations are also within the scope of the present disclosure.

Although not shown, in some embodiments, the social networking service system 210 provides an API module via which applications 120 and services can access various data and services provided or maintained by the social networking service. For example, using an API, an application may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service, nothing other than data privacy concerns prevents the API from being provided to the public or to certain third parties under special arrangements, thereby making the navigation recommendations available to third party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when member profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and member activity and behavior data (stored, e.g., in the member activity and behavior database 222), as well as job postings. The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

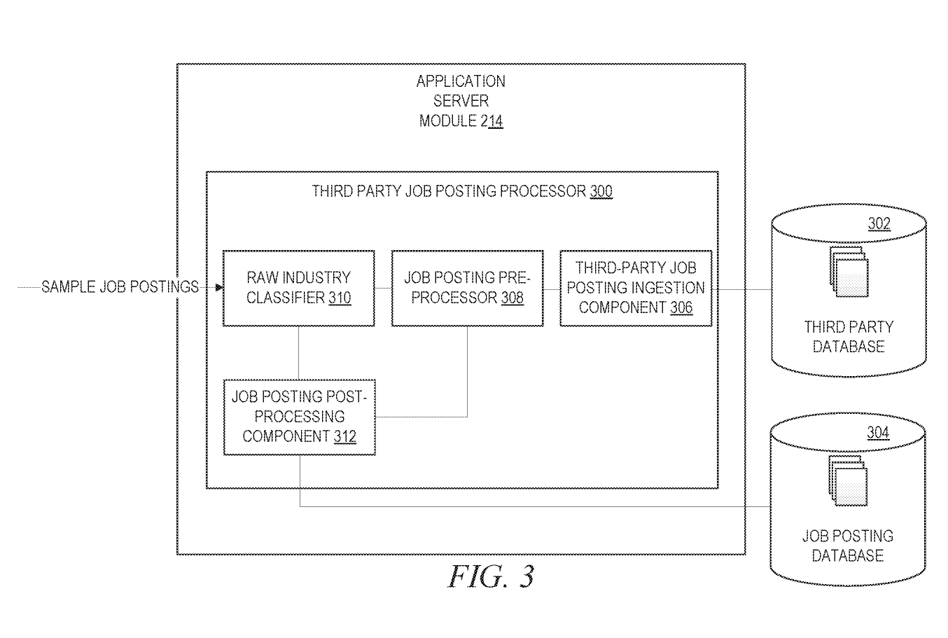

FIG. 3 is a block diagram illustrating application server module 214 of FIG. 2 in more detail. While in many embodiments the application server module 214 will contain many subcomponents used to perform various different actions within the social networking system, in FIG. 3 only those components that are relevant to the present disclosure are depicted. An third-party job posting processor 300 acts to process job postings from a third party database 302. This processing will be described in more detail later, but generally involves retrieving (i.e., “scraping”) job postings from one or more third-party databases 302 (in some example embodiments, over a computer network) and processing them for inclusion in job posting database 304, where the job postings may be indexed and searched by members of the social networking service.

The third party job posting processor 300 may include a third party job posting ingestion component 306, a job-posting pre-processor 308, a raw industry classifier 310, and a job posting post-processing component 312. The third-party job posting ingestion component 306 may ingest job postings from the third-party database 302 and/or other third-party sources. As described above, this process is generally called “scraping.” Also as described above, the scraped job postings may or may not be missing industry information for the companies to which the job postings pertain. A job posting pre-processor 308 separates out job postings that contain adequate industry information from those that do not. Any job postings that contain adequate industry information can proceed directly to the job posting post-processing component 312 (although in some cases it may be desirable to still run them through the raw industry classifier to verify or enhance the provided industry information). Any job postings missing industry information proceed first through raw industry classifier 310, which uses a machine learning algorithm (trained via sample job postings) to automatically assign one or more industries to each of the job postings. The job posting post-processing component 312 may then perform various post-processing steps on the job postings. This post processing may include company name standardization (e.g., assigning each company name identified in a job posting a normalized version of the company name to ensure consistency across job postings), as well as location standardization (e.g., assigning each location identified in a job posting a normalized version of the location to ensure consistency across job postings).

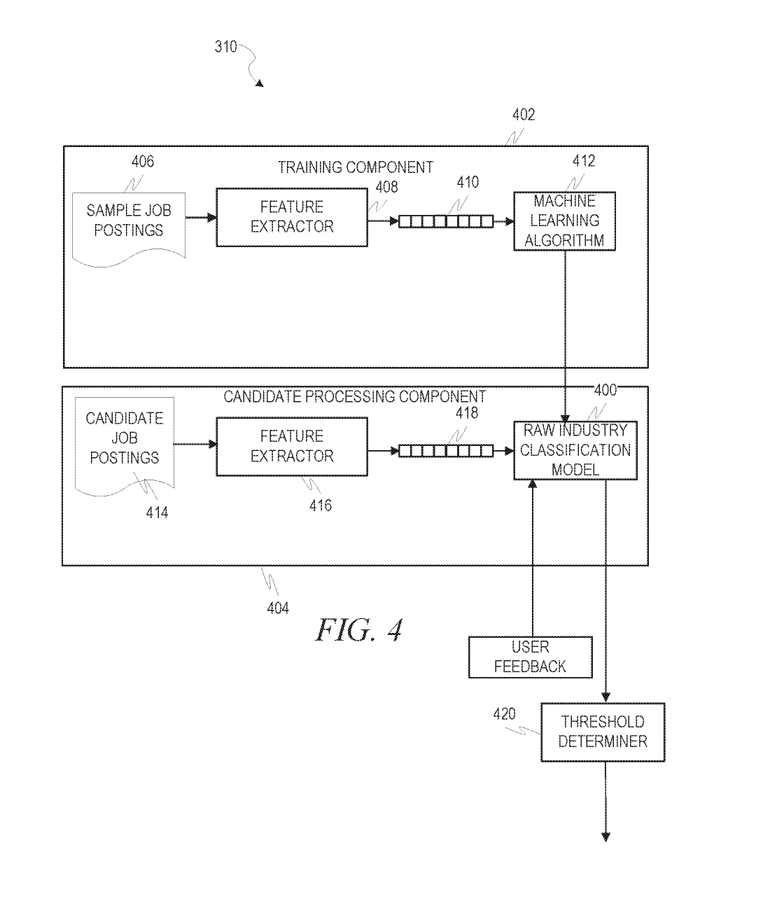

FIG. 4 is a block diagram illustrating a raw industry classifier 310 used to automatically add one or more industries to a job posting, in accordance with an example embodiment. The raw industry classifier 310 may utilize machine learning processes to arrive at a raw industry classification model 400 used to automatically assign one or more industries to raw job postings. The raw industry classifier 310 may comprise a training component 402 and a candidate processing component 404. The training component feeds sample job postings 406 from sample questionnaires into a feature extractor 408 that extracts one or more features 410 for the sample job postings 406. The sample job postings 406 may each include one or more labels indicating industries related to the company corresponding to the sample job posting 406. The features 410 are measurements useful in differentiating questions from one another and/or finding common ground in different questions. A machine learning algorithm 412 produces the raw industry classification model 400 using the extracted features 410 along with the one or more labels. In the candidate processing component 404, candidate job postings 414 are fed to a feature extractor 416 that extracts one or more features 418 from the candidate job postings 414. In an example embodiment, features 418 are identical to the features 410, although the values for the features will of course vary based on the job postings. These features 418 are then fed to the raw industry classification model 400, which outputs one or more industries for each record based on the model.

In some example embodiments, the one or more industries output by the raw industry classification model 400 include, for each of the one or more industries, an accuracy score. A threshold determiner 420 may then compare each of these scores to a preset accuracy threshold. In an example embodiment, if at least one of the output industries exceeds the preset accuracy threshold, then each of the industries is output. Thus, for example, the raw industry classification model 400 may be designed to always output up to three industries for each candidate job posting 414. If at least one of these three industries has an accuracy score exceeding the preset accuracy threshold, then all three of the industries are output as recommendations for industries to add to the candidate job posting 414. If none of these three industries has an accuracy score exceeding the preset accuracy threshold, then the job posting may be dropped and not forwarded to the job posting post-processing component 312 for post-processing.

It should be noted that the raw industry classification model 400 may be periodically updated via additional training and/or user feedback. The user feedback may be either feedback from members performing searches, or from companies corresponding to the job postings. The feedback may include an indication about how successful the raw industry classification model 400 is in predicting an industry for job postings based upon information in the job postings.

The machine learning algorithm 412 may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models, Examples of unsupervised learning algorithms include expectation-maximization algorithms, vector quantization, and information bottleneck method. In an example embodiment, a multi-class logistical regression model is used.

As described above, the training component 402 may operate in an offline manner to train the raw industry classification model 400. The candidate processing component 402, however, may be designed to operate in either an offline manner or an online manner. In an offline manner embodiment, the entire third party job posting processor 300 may be designed to periodically (e.g., once daily) obtain job postings from the third party database 302 and process those job postings as described above. In an online manner embodiment, either the candidate processing component 402 alone, or the candidate processing component 402 along with one or more other components of the third party job posting processor 300, may be designed to operate at runtime on each individual job posting.

There are various technical problems encountered in attempting to automatically assign an industry to a job posting. Among these technical problems are that the job description in a job posting may provide a very noisy signal for industry classification of a company, the training data may be heavily skewed if there are more jobs in few industries, a company may post lots of jobs in other domains or industries than their primary industry, and poor accuracy for predicting a single perfect industry for a company.

These technical problems may be addressed through a variety of solutions described herein.

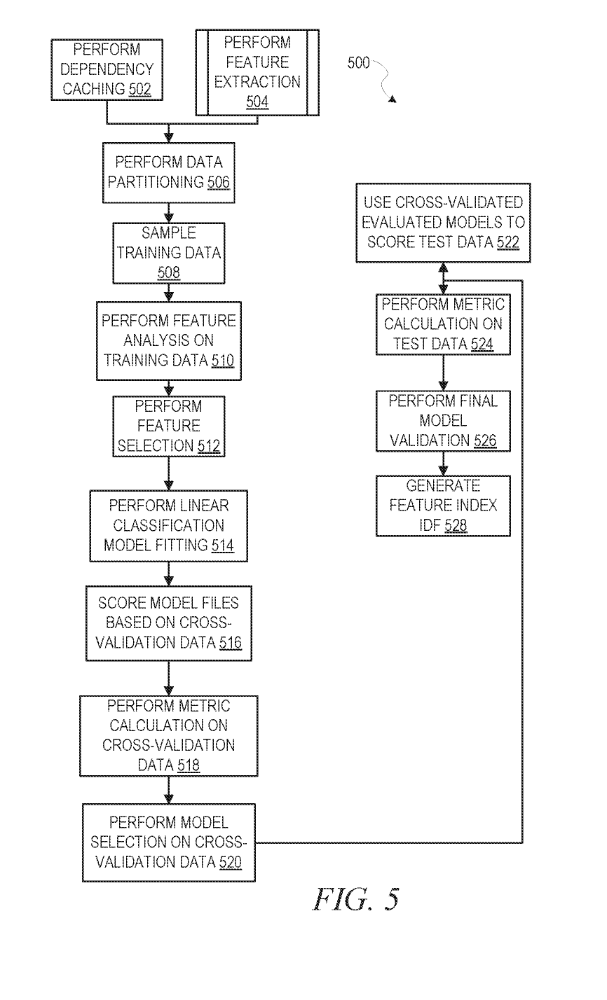

FIG. 5 is a flow diagram illustrating a method 500 of training of the raw industry classification model 400 in more detail, in accordance with an example embodiment. At operation 502, dependency caching is performed. Dependency caching involves caching all libraries and dependencies required by a workflow. A map/reduce framework may copy the necessary files onto a slave node before any tasks for the job posting are executed on that node. Dependency caching adds efficiency because files are only copied once per job posting and the ability to cache archives, which are unarchived on the slaves, allows for reuse if necessary.

At operation 504, feature extraction is performed. In an example embodiment, the job postings associated with each company identified in a job posting are aggregated, and the corpus of all terms in the aggregated job postings are considered as possible features of a job posting. One or more metrics associated with each of these terms is calculated, and these calculated metrics may then be used later to measure the strength of the association of the label(s) for a sample job posting with the terms contained therein.

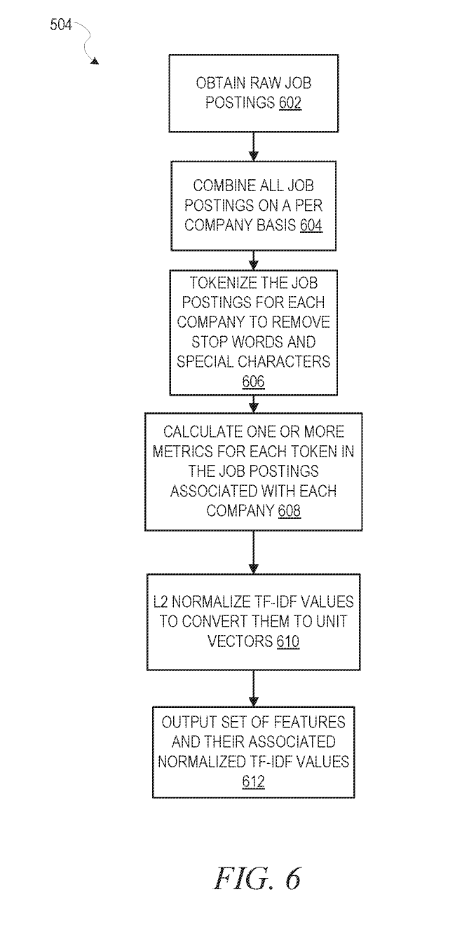

FIG. 6 is a flow diagram illustrating feature extraction 504 in more detail, in accordance with an example embodiment. At operation 600, raw job postings are obtained. In an example embodiment, these listings may have been stored in, for example, a Hadoop Distributed File System (HDFS directory). At operation 602, the raw job postings are then filtered to only select jobs that have a job state of “listed” and have valid (i.e., non-null, non-empty, and non negative) identifications in both company and industry fields. The identifications in the company fields are the labels applied to the training data.

At operation 604, all of the job postings are combined on a per company basis. Thus, in other words, all job postings pertaining to a particular company are combined into one aggregation, while all job postings pertaining to a different company are combined into a different aggregation. At operation 606, the job postings for each company are tokenized to remove any stop words and special characters. A stop word is any word designated as not having any relevance to the training of the raw industry classification model 400, and special characters are the same on a character basis. Thus, for example, common articles, such as a, an, and the, may be designated as stop words to be removed. Stop words may be a predetermined list of words.

At operation 608, the one or more metrics are calculated for each token in the job postings associated with each company. In an example embodiment, the one or more metrics include term frequency-inverse document frequency (TF-IDF). TF-IDF reflects how important a token in to the job postings associated with each company.

At operation 610, the TF-IDF values are L2 normalized to convert them to unit vectors. At operation 612, the set of features and their associated normalized TF-IDF values are output. As will be seen, the TD-IDF values will be later used during the creation of a feature index IDF mapping file that is used to create the IT-IDF features from the query terms for the job posting under test.

Referring back to FIG. 5, at operation 506, data partitioning is performed. This process partitions the data into three parts: training data, cross-validation data, and test data. The way these partitions are created varies with the implementation. In some example embodiments, certain training data has been predesignated to be used for training data, cross-validation data, and test data and these designations may be used to partition the data. In other example embodiments, sample job postings are assigned as training data until a preset limit is met, at which point further job postings are assigned as cross-validation data. Then later, if an administrator wishes to test the reliability of the raw industry classification model 400, the sample job postings utilized are designated as test data.

At operation 508, the training data is sampled. In an example embodiment, a biased stratified sampling of the training data is performed to create balanced samples per labels. At operation 510, feature analysis on the training data is performed. Since the features are derived from textual data and each term (not filtered out) is considered as a feature, there may be several features that are not very useful in distinguishing one label from another. The goal of feature analysis is to find features that have a high correlation with the label. In an example embodiment, for each feature, a feature-label correlation is computed using a Chi square estimator.

At operation 512, feature selection is performed. In an example embodiment, the trainer may be limited to select the top X number of features that have a high correlation coefficient. In an example embodiment, X is 50,000.

At operation 514, linear classification model fitting is performed. The training data with the selected features form the input for the model fitting process. In addition, three other inputs may be specified. These include regularization types (e.g., L1, L2), regularization constants (e.g., 0.01, 0.1, 0.25, 0.5, 1, 10), and termination tolerances (0.001, 0.01). The linear classification model fitting stages train a model for each of the above parameter configurations independently, and these model files are then scored. In this operation, the feature names and labels are converted to indices representing the row and column indices, respectively, in the matrix used for model fitting.

At operation 516, the model files are scored based on cross-validation data. This uses the learned model coefficients to make predictions for each of the records in the cross-validation data, and then the results of such predictions are scored. At operation 518, metric calculation is performed on the cross-validation data. Here, two main categories of metrics are created for the scored cross-validation data. These categories include scalar metrics (e.g., average, geometric mean and harmonic mean of accuracy, precision, recall, and F-1 score), and vector metrics (e.g., per class true positive rate, false positive rate, false negative rate, true negative rate, accuracy, precision, recall, and F-1 Score). These scored metrics are then stored.

At operation 520, model selection is performed on cross-validation data. This uses the metrics calculated previously to pick the models that satisfy a specified selection constraint. In an example embodiment, average subset accuracy may be used for model selection with a threshold of 0.25. This lower value helps correct for noisy description data.

At operation 522, the cross validated evaluated models are used to score the test data. This operation is similar to operation 516, but uses test data instead of cross-validation data. At operation 524, metric calculation is performed on the test data. This operation is similar to operation 518, but uses test data instead of cross-validation data.

At operation 526, final model validation is performed. In this operation, a single model having the top metric that meets the specified threshold (e.g., average subset accuracy) is selected. At operation 528, a feature index IDF is generated. As described above, during operation 514, the feature names and labels are converted to indices representing the row and column indices, respectively, in the matrix used for model fitting. The resulting model therefore has coefficients defined in the order of these indices. Operation 526 involves combining the identifications and the feature mapping to create a tuple for each record. This tuple includes the selected feature name, feature index, and the IDF for that feature. This file will be used by the candidate processing component 402 for two reasons. Since the model was trained with strong features and only has coefficients for those features, the candidate processing component 402 should drop features that were not used in the training. Also, the IDFs are calculated on the corpus of the text used during training and is used for the TF-IDF calculation of candidate job postings.

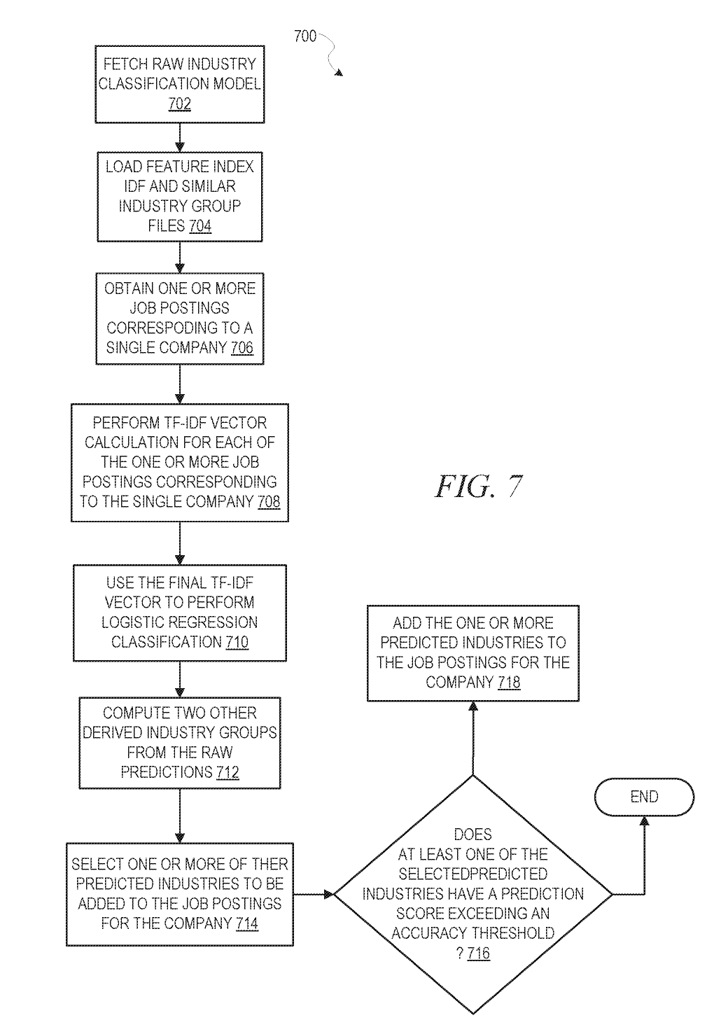

FIG. 7 is a flow diagram illustrating a method 700 of classifying industries for candidate job postings using a raw industry classification model 400, in accordance with an example embodiment. At operation 702, the raw industry classification model 400 is fetched. At operation 704, the feature index IDF and similar industry group files are loaded. At operation 706, one or more job postings corresponding to a single company (e.g., containing the same normalized company name/identification) are obtained. At operation 708, TF-IDF vector calculation is performed for each of the terms in one or more job postings corresponding to the single company. At operation 710, the final TF-IDF vector is used to perform logistic regression classification, which uses the learned coefficients to output the top k k=3) predictions with their prediction scores. At operation 712, the job-posting post-processing component 312 may compute two other derived industry groups from the raw predictions. The first is the top k+ similar industries. This is computed by combining a list of the top k industries from the previous operation as well as every industry similar to each of the top k industries (as identified in an industry similarity table). The second is top k dissimilar industry, which comprises picking the top k industries so that no 2 industries in the set are similar. This helps give breadth to the predicted industries to be assigned to each job posting, with the recognition that is better to have industries that perhaps are not actually relevant to the job posting listed in the job posting than to not have an industry that is relevant to the job posting, as in the latter case a search by a member on the industry would yield no results, whereas in the former the member could always filter out results he or she views as unrelated.

At operation 714, one or more of the predicted industries are selected to be added to the job postings for the company. These are selected from among the industries identified in operation 710 and/or operation 712. At operation 716, it is determined if at least one of the selected predicted industries has a prediction score exceeding an accuracy threshold. If so, then at operation 718, the one or more predicted industries are added to the job postings for the company. If not, then the process ends.

In an example embodiment, the prediction scores may be calculated by a validation response handler. This validation response handler computes the following statistics:

a. Top performing metric per industry: raw top 3, top 3+similar or top k dissimilar
b. Prediction accuracy per employer group
c. Average prediction metric accuracy
d. Total number of industries tagged
e. Total number of industries tagged for companies with low company standardizer score.
f. Total jobs tagged by industry
g. Total jobs skipped due to low accuracy
h. Company and job Industry overrides by Analyst/Quality Assurance (QA)

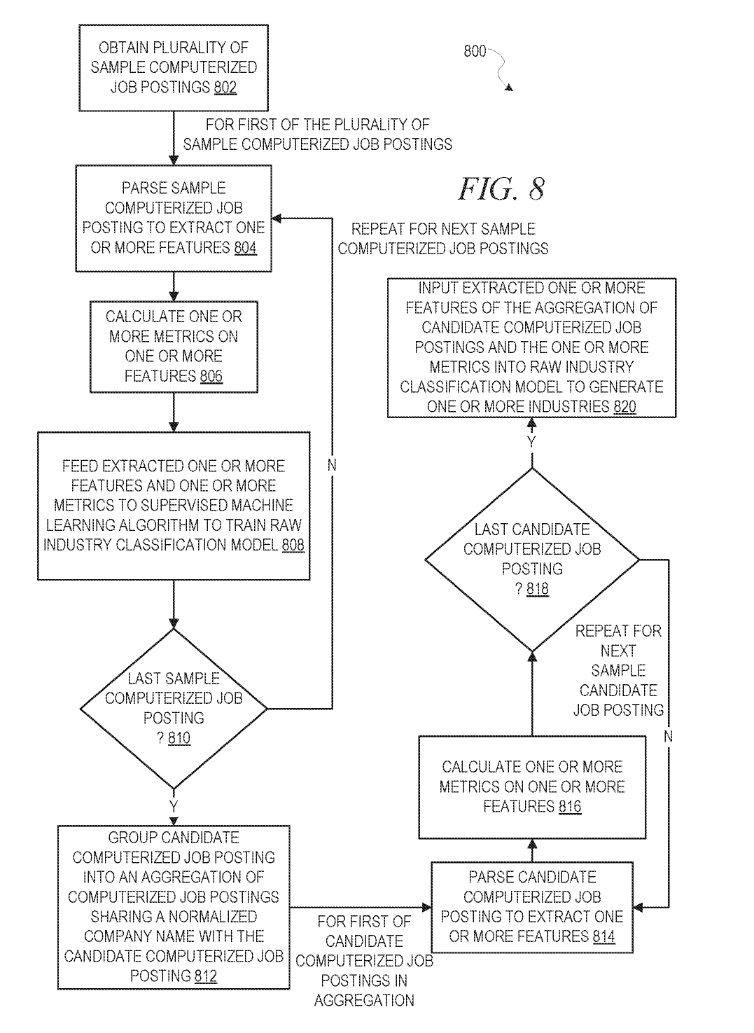

FIG. 8 is a flow diagram illustrating a method 800 for automatically assigning an industry to a candidate computerized job posting using a machine learning algorithm, in accordance with an example embodiment. At operation 802, a plurality of sample computerized job postings are obtained. Each of the plurality of sample computerized job postings contains a labeled industry. This plurality may comprise the training set of sample computerized job postings (there may be other sets of sample computerized job postings used for, for example, cross-verification and/or testing). A loop is then begun for each of the plurality of sample computerized job postings. At operation 804, the sample computerized job posting is parsed to extract one or more features of the sample computerized job posting. The one or more features may include, for example, a filtered list of terms in a textual portion of the sample computerized job posting. At operation 806, one or more metrics are calculated for the one or more features of the sample computerized job posting. These metrics may include, for example, TF-IDF. At operation 808, the extracted one or more features and corresponding one or more metrics are fed into a supervised machine learning algorithm to train a raw industry classification model based on the extracted one or more features by correlating some of the one or more features with the labeled industry of the sample computerized job posting based on the one or more metrics. At operation 810, it is determined if this is the last sample computerized job posting. If not, then the method 800 loops back to operation 804. If so, then at operation 812, the candidate computerized job posting is grouped into an aggregation of computerized job postings sharing a normalized company name with the candidate computerized job posting. A loop is then begun for each candidate computerized job posting in the aggregation of computerized job postings sharing the normalized company name. At operation 814, the candidate computerized job posting is parsed to extract one or more features of the candidate computerized job posting. At operation 816, the one or more metrics are calculated for the one or more features of the sample computerized job posting. At operation 818, it is determined if this is the last candidate computerized job posting in the aggregation. If not, then the method 800 loops back to operation 814. If so, then at operation 820, the extracted one or more features of the aggregation of candidate computerized job postings and the one or more metrics are input into the raw industry classification model to generate one or more industries associated with the normalized company name based on the one or more features of the aggregation of candidate computerized job postings and the one or more metrics.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-7 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internee of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Software Architecture

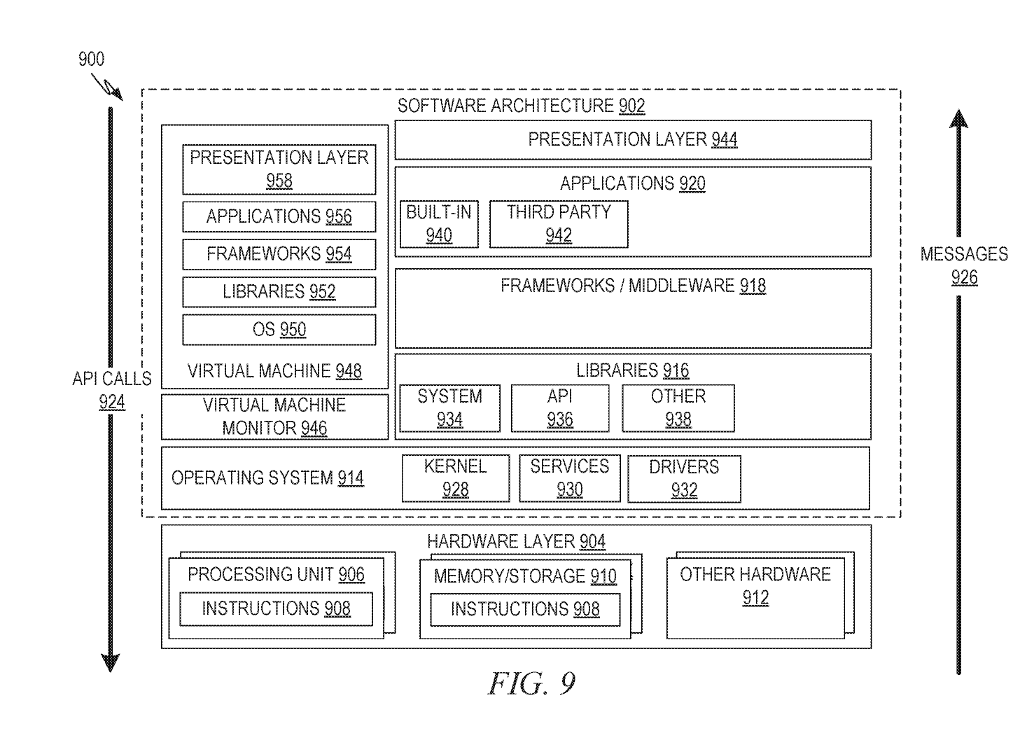

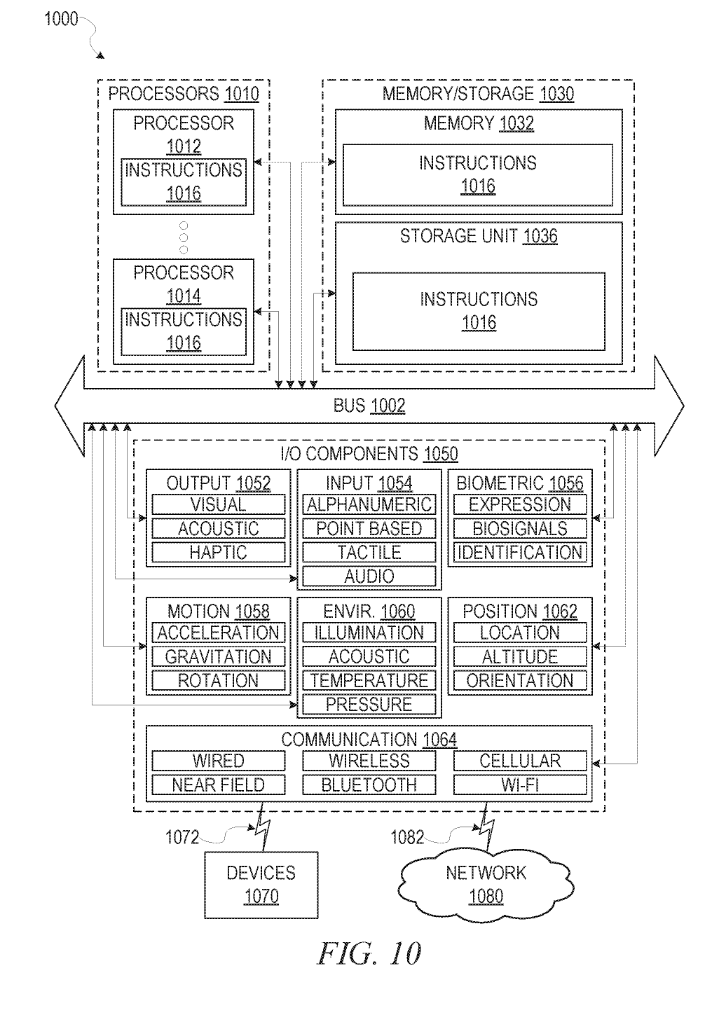

FIG. 9 is a block diagram 900 illustrating a representative software architecture 902, which may be used in conjunction with various hardware architectures herein described. FIG. 9 is merely a non-limiting example of a software architecture, and it will be appreciated that many other architectures may be implemented to facilitate the functionality described herein. The software architecture 902 may be executing on hardware such as a machine 1000 of FIG. 10 that includes, among other things, processors 1010, memory/storage 1030, and I/O components 1050. A representative hardware layer 904 is illustrated and can represent, for example, the machine 1000 of FIG. 10. The representative hardware layer 904 comprises one or more processing units 906 having associated executable instructions 908. The executable instructions 908 represent the executable instructions of the software architecture 902, including implementation of the methods, modules, and so forth of FIGS. 1-7. The hardware layer 904 also includes memory and/or storage modules 910, which also have the executable instructions 908. The hardware layer 904 may also comprise other hardware 912, which represents any other hardware of the hardware layer 904, such as the other hardware illustrated as part of the machine 1000.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and a presentation layer 944. Operationally, the applications 920 and/or other components within the layers may invoke API calls 924 through the software stack and receive responses, returned values, and so forth, illustrated as messages 926, in response to the API calls 924. The layers illustrated are representative in nature and not all software architectures have all layers. For example, some mobile or special purpose operating systems may not provide a layer of frameworks/middleware 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than by interfacing directly with the underlying operating system 914 functionality (e.g., kernel 928, services 930, and/or drivers 932). The libraries 916 may include system 934 libraries (e.g., C standard library that may provide functions such as memory allocation functions, string manipulation functions, mathematic functions, and the like. In addition, the libraries 916 may include API 936 libraries such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 and/or other software components/modules. For example, the frameworks 918 may provide various graphic user interface (GUI) functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 include built-in applications 940 and/or third party applications 942. Examples of representative built-in applications 940 may include, but are not limited to, a contacts application, a browser application, a book reader application, a location application, a media application, a messaging application, and/or a game application. The third party applications 942 may include any of the built-in applications as well as a broad assortment of other applications. In a specific example, the third party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 942 may invoke the API calls 924 provided by the mobile operating system such as the operating system 914 to facilitate functionality described herein.

The applications 920 may utilize built-in operating system 914 functions (e.g., kernel 928, services 930, and/or drivers 932), libraries 916 (e.g., system 934, APIs 936, and other libraries 938), and frameworks/middleware 918 to create user interfaces to interact with users of the system. Alternatively, or additionally, in some systems, interactions with a user may occur through a presentation layer, such as the presentation layer 944. In these systems, the application/module “logic” can be separated from the aspects of the application/module that interact with a user.

Some software architectures utilize virtual machines. In the example of FIG. 9, this is illustrated by a virtual machine 948. A virtual machine creates a software environment where applications/modules can execute as if they were executing on a hardware machine (such as the machine 1000 of FIG. 10, for example). A virtual machine is hosted by a host operating system (e.g., operating system 914 in FIG. 9) and typically, although not always, has a virtual machine monitor 946, which manages the operation of the virtual machine as well as the interface with the host operating system (e.g., operating system 914). A software architecture executes within the virtual machine 948, such as an operating system 950, libraries 952, frameworks/middleware 954, applications 956, and/or a presentation layer 958. These layers of software architecture executing within the virtual machine 948 can be the same as corresponding layers previously described or may be different.

### Example Machine Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex instruction Set Computing (CISC) processor, a Graphics Processing Unit (GPU), a Digital Signal Processor (DSP), an ASIC, a Radio-Frequency Integrated. Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory; storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine (e.g., processors 1010), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or other suitable device to interface with the network 1080. In further examples, the communication components 1064 may include wired communication components, wireless communication components, cellular communication components, Near Field Communication (NEC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computerized method of automatically assigning an industry to a candidate computerized job posting using a machine learning algorithm, the method comprising:
in a training process:
obtaining a plurality of sample computerized job postings, each of the plurality of sample computerized job postings containing a labeled industry;
for each of the plurality of sample computerized job postings:
parsing the sample computerized job posting to extract one or more features of the sample computerized job posting;
calculating one or more metrics for the one or more features of the sample computerized job posting;
feeding the extracted one or more features and corresponding one or more metrics into a supervised machine learning algorithm to train a raw industry classification model based on the extracted one or more features by correlating some of the one or more features with the labeled industry of the sample computerized job posting based on the one or more metrics;
in a classification process:
grouping the candidate computerized job posting into an aggregation of computerized job postings sharing a normalized company name with the candidate computerized job posting;
for each candidate computerized job posting in the aggregation of computerized job postings sharing the normalized company name:
parsing the candidate computerized job posting to extract one or more features of the candidate computerized job posting; and
calculating the one or more metrics for the one or more features of the sample computerized job posting; and
inputting the extracted one or more features of the aggregation of candidate computerized job postings and the one or more metrics into the raw industry classification model to generate one or more industries associated with the normalized company name based on the one or more features of the aggregation of candidate computerized job postings and the one or more metrics.

2. The computerized method of claim 1, wherein the raw industry classification model is a linear classification model.

3. The computerized method of claim 1, wherein each of the one or more features is a term in a textual portion of the computerized job posting and the one or more metrics includes term frequency-inverse document frequency (TF-IDF) for the corresponding term.

4. The computerized method of claim 1, wherein the feeding includes utilizing a Chi square estimator to establish a correlation between the one or more features and the labeled industry of the sample computerized job posting.

5. The computerized method of claim 1, wherein the classification process further comprises:
producing a prediction score for each of the one or more industries;
comparing the prediction score for each of the one or more industries to a threshold prediction score; and
in response to a determination that the prediction score for at least one of the one or more industries transgressed the threshold prediction score, altering the candidate computerized job posting to include all of the one or more industries.

6. The computerized method of claim 5, wherein producing a prediction score comprises:
calculating an average prediction metric accuracy for each of the one or more industries using test job postings input to the raw industry classification model and comparing test output from the raw industry classification model to labels on each of the test job postings.

7. The computerized method of claim 5, wherein the one or more industries include a top k predicted industries that are dissimilar from each other for the candidate computerized job posting.

8. A system for automatically assigning an industry to a candidate computerized job posting using a machine learning algorithm, the system comprising:
a computer readable medium having instructions stored there on, which, when executed by a processor, cause the system to:
in a training process:
obtain a plurality of sample computerized job postings, each of the plurality of sample computerized job postings containing a labeled industry;
for each of the plurality of sample computerized job postings:
parse the sample computerized job posting to extract one or more features of the sample computerized job posting;
calculate one or more metrics for the one or more features of the sample computerized job posting;
feed the extracted one or more features and corresponding one or more metrics into a supervised machine learning algorithm to train a raw industry classification model based on the extracted one or more features by correlating some of the one or more features with the labeled industry of the sample computerized job posting based on the one or more metrics;
in a classification process:
group the candidate computerized job posting into an aggregation of computerized job postings sharing a normalized company name with the candidate computerized job posting;
for each candidate computerized job list in the aggregation of computerized job postings sharing the normalized company name:
parse the candidate computerized job posting to extract one or more features of the candidate computerized job posting;
calculate the one or more metrics for the one or more features of the sample computerized job posting; and
input the extracted one or more features of the aggregation of candidate computerized job postings and the one or more metrics into the raw industry classification model to generate one or more industries associated with the normalized company name based on the one or more features of the aggregation of candidate computerized job postings and the one or more metrics.

9. The system of claim 8, wherein the raw industry classification model is a linear classification model.

10. The system of claim 8, wherein each of the one or more features is a term in a textual portion of the computerized job list and the one or more metrics includes term frequency-inverse document frequency (TF-IDF) for the corresponding term.

11. The system of claim 8, wherein the feeding includes utilize a Chi square estimator to establish a correlation between the one or more features and the labeled industry of the sample computerized job posting.

12. The system of claim 8, wherein the classification process further comprises:
produce a prediction score for each of the one or more industries;
compare the prediction score for each of the one or more industries to a threshold prediction score; and
in response to a determination that the prediction score for at least one of the one or more industries transgressed the threshold prediction score, alter the candidate computerized job posting to include all of the one or more industries.

13. The system of claim 12, wherein producing a prediction score comprises:
calculating an average prediction metric accuracy for each of the one or more industries using test job postings input to the raw industry classification model and comparing test output from the raw industry classification model to labels on each of the test job postings.

14. The system of claim 12, wherein the one or more industries include a top k predicted industries that are dissimilar from each other for the candidate computerized job posting.

15. A non-transitory computer-readable storage medium for, the computer-readable storage medium including instructions that, when implemented by one or more machines, cause the one or more machines to perform operations comprising:
in a training process:
obtaining a plurality of sample computerized job postings, each of the plurality of sample computerized job postings containing a labeled industry;
for each of the plurality of sample computerized job postings:
parsing the sample computerized job posting to extract one or more features of the sample computerized job posting;
calculating one or more metrics for the one or more features of the sample computerized job posting;
feeding the extracted one or more features and corresponding one or more metrics into a supervised machine learning algorithm to train a raw industry classification model based on the extracted one or more features by correlating some of the one or more features with the labeled industry of the sample computerized job posting based on the one or more metrics;
in a classification process:
grouping the candidate computerized job posting into an aggregation of computerized job postings sharing a normalized company name with the candidate computerized job posting;
for each candidate computerized job posting in the aggregation of computerized job postings sharing the normalized company name:
parsing the candidate computerized job posting to extract one or more features of the candidate computerized job posting; and
calculating the one or more metrics for the one or more features of the sample computerized job posting; and
inputting the extracted one or more features of the aggregation of candidate computerized job postings and the one or more metrics into the raw industry classification model to generate one or more industries associated with the normalized company name based on the one or more features of the aggregation of candidate computerized job postings and the one or more metrics.

16. The non-transitory machine-readable storage medium of claim 15, wherein the raw industry classification model is a linear classification model.

17. The non-transitory machine-readable storage medium of claim 15, wherein each of the one or more features is a term in a textual portion of the computerized job posting and the one or more metrics includes term frequency-inverse document frequency (TF-IDF) for the corresponding term.

18. The non-transitory machine-readable storage medium of claim 15, wherein the feeding includes utilizing a Chi square estimator to establish a correlation between the one or more features and the labeled industry of the sample computerized job posting.

19. The non-transitory machine-readable storage medium of claim 15, wherein the classification process further comprises:
producing a prediction score for each of the one or more industries;
comparing the prediction score for each of the one or more industries to a threshold prediction score; and
in response to a determination that the prediction score for at least one of the one or more industries transgressed the threshold prediction score, altering the candidate computerized job posting to include all of the one or more industries.

20. The non-transitory machine-readable storage medium of claim 19, wherein producing a prediction score comprises:
calculating an average prediction metric accuracy for each of the one or more industries using test job postings input to the raw industry classification model and comparing test output from the raw industry classification.
